(19) United States
(12) Patent Application Publication
(10) Pub. No.: US 2022/0371588 A1
(43) Pub. Date: Nov. 24, 2022

(54) INTELLIGENT ADAPTIVE CRUISE CONTROL FOR LIGHT-COMPROMISED CONDITIONS

(71) Applicant: Ford Global Technologies, LLC, Dearborn, MI (US)

(72) Inventors: Keith Weston, Canton, MI (US); Andrew Denis Lewandowski, Sterling Heights, MI (US); Brendan F. Diamond, Grosse Pointe, MI (US); Jordan Barrett, Milford, MI (US)

(73) Assignee: Ford Global Technologies, LLC, Dearborn, MI (US)

(21) Appl. No.: 17/326,782

(22) Filed: May 21, 2021

(51) Int. Cl. B60W 30/16; G01C 21/00; H04N 5/235

(52) U.S. Cl. CPC B60W 30/16; G01C 21/3889; H04N 5/2351; B60W 2420/42; B60W 2420/40; B60W 2555/20

(57) ABSTRACT

A system comprises a computer having a processor and a memory, the memory storing instructions executable by the processor to obtain, while an adaptive cruise control feature of a vehicle traveling a roadway is set to operate in a standard operation mode, lighting condition data for an on-board camera of the vehicle, determine, based on the lighting condition data, whether the on-board camera is subject to a lighting-compromised condition, and responsive to a determination that the on-board camera is subject to the lighting-compromised condition, cause the adaptive cruise control feature to operate in a modified operation mode, wherein during operation in the modified operation mode, the adaptive cruise control feature operates in accordance with one or more modified operating parameters.

### BACKGROUND

Adaptive cruise control is a vehicle feature that, when engaged, controls vehicle propulsion power/acceleration in order to maintain a set speed to the extent possible, while monitoring the road in front of the vehicle in order to detect other vehicles that may be present. When the adaptive cruise control feature detects the presence of a slower-moving vehicle in front of the controlled vehicle, it can temporarily reduce the speed of the controlled vehicle below the set speed in order to maintain a desired minimum following distance. Subsequently, if the adaptive cruise control feature detects that the road in front of the vehicle has become clear, it can cause the vehicle to accelerate back up to the set speed.

### BRIEF DESCRIPTION OF THE DRAWINGS

FIG. 1 is a block diagram of a first example system.

FIG. 2 is a block diagram of an example server.

FIG. 3 is a diagram of an example traffic scene.

FIG. 4 is a block diagram of a second example system.

FIG. 5 is a block diagram of an example process flow.

FIG. 6 is a block diagram of an example storage medium.

### DETAILED DESCRIPTION

Disclosed herein are adaptive cruise control improvements according to which adaptive cruise control operating parameters can be intelligently adjusted to optimize adaptive cruise control performance when lighting conditions hamper the performance/capabilities of on-board cameras with respect to obstacle detection. Such adjustments can include, for example, changes to following distances, target speeds, acceleration/deceleration rates, acceleration/deceleration delay intervals, and other parameters. Multiple types of light-compromised conditions can be recognized, and the parameter adjustments can be tailored to the particular type of condition that is detected.

A system can comprise a computer having a processor and a memory, the memory storing instructions executable by the processor to obtain, while an adaptive cruise control feature of a vehicle traveling a roadway is set to operate in a standard operation mode, lighting condition data for an on-board camera of the vehicle, determine, based on the lighting condition data, whether the on-board camera is subject to a lighting-compromised condition, and responsive to a determination that the on-board camera is subject to the lighting-compromised condition, cause the adaptive cruise control feature to operate in a modified operation mode, wherein during operation in the modified operation mode, the adaptive cruise control feature operates in accordance with one or more modified operating parameters.

The lighting condition data can include sun orientation data indicating an orientation of the sun relative to an orientation of the vehicle.

The lighting condition data can include light attenuation data indicating at least one of an extent of cloud coverage at the location of the vehicle and an extent of precipitation at the location of the vehicle.

The lighting condition data can include supplemental lighting data describing an extent of supplemental lighting at the location of the vehicle.

The memory can store instructions executable by the processor to determine the location of the vehicle based on geolocation data and obtain the supplemental lighting data from map data based on the location of the vehicle.

The lighting condition data can include light sensing data obtained from a light sensor of the vehicle.

The memory can store instructions executable by the processor to obtain at least a portion of the lighting condition data by processing camera sensor data obtained from the on-board camera.

The memory can store instructions executable by the processor to determine whether the on-board camera is subject to the lighting-compromised condition based on the lighting condition data and a current time of day.

The one or more modified operating parameters can include a modified following distance parameter.

The one or more modified operating parameters can include a modified target speed parameter.

A method can comprise obtaining, while an adaptive cruise control feature of a vehicle traveling a roadway is set to operate in a standard operation mode, lighting condition data for an on-board camera of the vehicle, determining, based on the lighting condition data, whether the on-board camera is subject to a lighting-compromised condition, and responsive to a determination that the on-board camera is subject to the lighting-compromised condition, causing the adaptive cruise control feature to operate in a modified operation mode, wherein during operation in the modified operation mode, the adaptive cruise control feature operates in accordance with one or more modified operating parameters.

The lighting condition data can include sun orientation data indicating an orientation of the sun relative to an orientation of the vehicle.

The lighting condition data can include light attenuation data indicating at least one of an extent of cloud coverage at the location of the vehicle and an extent of precipitation at the location of the vehicle.

The lighting condition data can include supplemental lighting data describing an extent of supplemental lighting at the location of the vehicle.

The method can comprise determining the location of the vehicle based on geolocation data and obtaining the supplemental lighting data from map data based on the location of the vehicle.

The lighting condition data can include light sensing data obtained from a light sensor of the vehicle.

The method can comprise obtaining at least a portion of the lighting condition data by processing camera sensor data obtained from the on-board camera.

The method can comprise determining whether the on-board camera is subject to the lighting-compromised condition based on the lighting condition data and a current time of day.

The one or more modified operating parameters can include a modified following distance parameter.

The one or more modified operating parameters can include a modified target speed parameter.

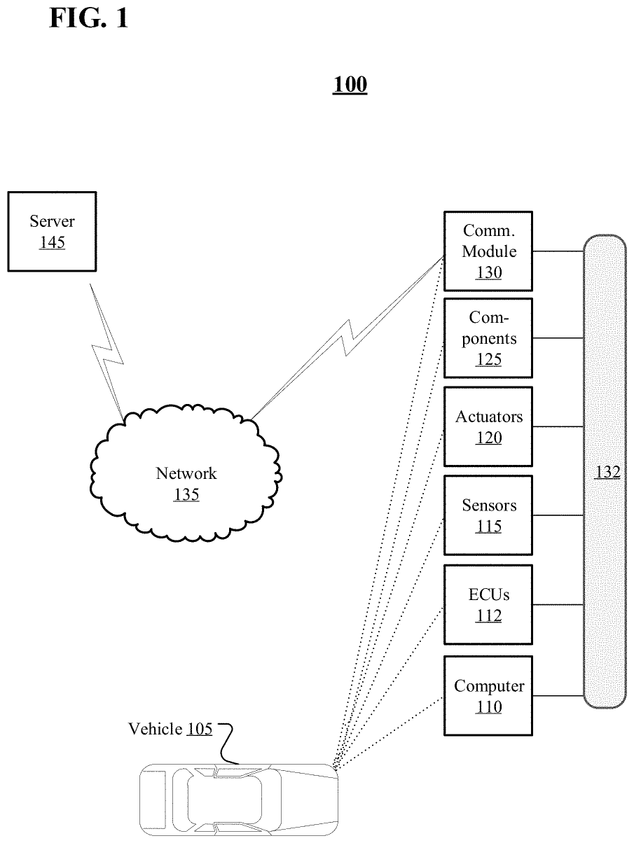

FIG. 1 is a block diagram of an example vehicle system 100. The system 100 includes a vehicle 105, which is a land vehicle such as a car, truck, etc. The vehicle 105 includes a computer 110, electronic control units (ECUs) 112, vehicle sensors 115, actuators 120 to actuate various vehicle components 125, a communications module 130, and a vehicle network 132. Communications module 130 allows vehicle 105 to communicate with a server 145 via a network 135.

The computer 110 includes a processor and a memory. The memory includes one or more forms of computer-readable media, and stores instructions executable by the processor for performing various operations, including as disclosed herein. The processor can be implemented using any suitable processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor, or any other suitable microprocessor or central processing unit (CPU). The processor also can be implemented as a dedicated processor, such as a controller, a microcontroller, an embedded processor, a chip multiprocessor (CMP), a co-processor, a graphics processor, a graphics processing unit (GPU), a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In some implementations, computer 110 can include multiple processors, each one of which can be implemented according to any of the examples above.

The computer 110 may operate vehicle 105 in an autonomous, a semi-autonomous mode, or a non-autonomous (manual) mode, i.e., can control and/or monitor operation of the vehicle 105, including controlling and/or monitoring components 125. For purposes of this disclosure, an autonomous mode is defined as one in which each of vehicle propulsion, braking, and steering are controlled by the computer 110; in a semi-autonomous mode the computer 110 controls one or two of vehicle propulsion, braking, and steering; in a non-autonomous mode a human operator controls each of vehicle propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may be communicatively coupled to, e.g., via vehicle network 132 as described further below, one or more processors located in other device(s) included in the vehicle 105. Further, the computer 110 may communicate, via communications module 130, with a navigation system that uses the Global Position System (GPS). As an example, the computer 110 may request and receive location data of the vehicle 105. The location data may be in a conventional format, e.g., geo-coordinates (latitudinal and longitudinal coordinates).

ECUs 112 (which can also be referred to as electronic control modules (ECMs) or simply as “control modules”) are computing devices that monitor and/or control various vehicle components 125 of vehicle 105. Examples of ECUs 112 can include an engine control module, a transmission control module, a powertrain control module, a brake control module, a steering control module, and so forth. Any given ECU 112 can include a processor and a memory. The memory can include one or more forms of computer-readable media, and can store instructions executable by the processor for performing various operations, including as disclosed herein. The processor of any given ECU 112 can be implemented using a general-purpose processor or a dedicated processor or processing circuitry, including any of the examples identified above in reference to a processor included in computer 110.

In some implementations, the processor of a given ECU 112 can be implemented using a microcontroller. In some implementations, the processor of a given ECU 112 can be implemented using a dedicated electronic circuit including an ASIC that is manufactured for a particular operation, e.g., an ASIC for processing sensor data and/or communicating the sensor data. In some implementations, the processor of a given ECU 112 can be implemented using an FPGA, which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of general-purpose processor(s), ASIC(s), and/or FPGA circuits may be included in a given ECU 112.

Vehicle network 132 is a network via which messages can be exchanged between various devices in vehicle 105. Computer 110 can be generally programmed to send and/or receive, via vehicle network 132, messages to and/or from other devices in vehicle 105 (e.g., any or all of ECUs 112, sensors 115, actuators 120, components 125, communications module 130, a human machine interface (HMI), etc.). Additionally or alternatively, messages can be exchanged among various such other devices in vehicle 105 via vehicle network 132. In cases in which computer 110 actually comprises a plurality of devices, vehicle network 132 may be used for communications between devices represented as computer 110 in this disclosure. Further, as mentioned below, various controllers and/or vehicle sensors 115 may provide data to the computer 110.

In some implementations, vehicle network 132 can be a network in which messages are conveyed via a vehicle communications bus. For example, vehicle network can include a controller area network (CAN) in which messages are conveyed via a CAN bus, or a local interconnect network (LIN) in which messages are conveyed via a LIN bus.

In some implementations, vehicle network 132 can include a network in which messages are conveyed using other wired communication technologies and/or wireless communication technologies (e.g., Ethernet, WiFi, Bluetooth, etc.). Additional examples of protocols that may be used for communications over vehicle network 132 in some implementations include, without limitation, Media Oriented System Transport (MOST), Time-Triggered Protocol (TTP), and FlexRay.

In some implementations, vehicle network 132 can represent a combination of multiple networks, possibly of different types, that support communications among devices in vehicle 105. For example, vehicle network 132 can include a CAN in which some devices in vehicle 105 communicate via a CAN bus, and a wired or wireless local area network in which some device in vehicle 105 communicate according to Ethernet or Wi-Fi communication protocols.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles), etc., relative to the location of the vehicle 105. The vehicle sensors 115 may further include camera sensor(s) 115, e.g., front view, side view, rear view, etc., providing images from a field of view inside and/or outside the vehicle 105.

Actuators 120 are implemented via circuitry, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via communication module 130 with devices outside of the vehicle 105, e.g., through vehicle-to-vehicle (V2V) or vehicle-to-infrastructure (V2X) wireless communications to another vehicle, to (typically via the network 135) a remote server 145. The communications module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC) and cellular V2V (CV2V), cellular V2X (CV2X), etc.), local area networks (LAN) and/or wide area networks (WAN), including the Internet, providing data communication services.

Computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

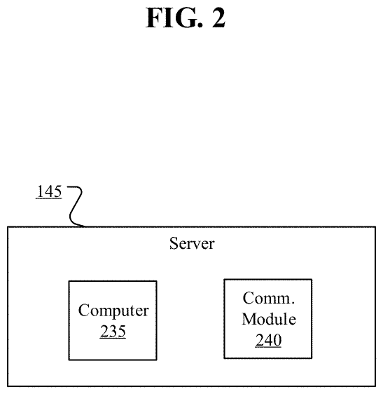

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 can include conventional mechanisms for wired and/or wireless communications, e.g., radio frequency communications using suitable protocols, that allow computer 235 to communicate with other devices, such as the vehicle 105, via wireless and or wired communication networks/links.

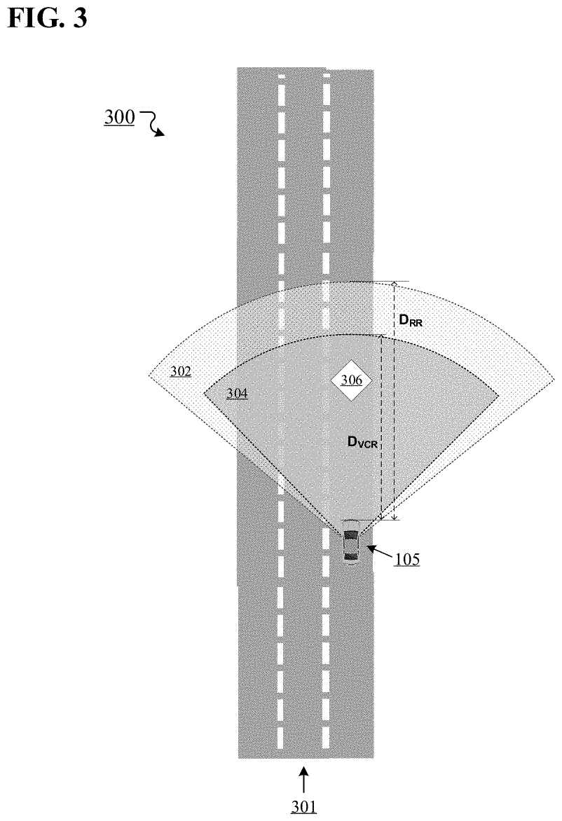

FIG. 3 is a diagram of an example traffic scene 300. In traffic scene 300, while an adaptive cruise control feature of vehicle 105 is engaged and set to operate in a standard operation mode, vehicle 105 travels a roadway 301. While engaged, the adaptive cruise control feature of vehicle 105 can control vehicle propulsion power/acceleration to maintain a set speed to the extent possible, while monitoring a road, e.g., typically the road in front of vehicle 105, to detect other vehicles that may be present. When the adaptive cruise control feature detects the presence of a vehicle in front of vehicle 105, it can determine whether vehicle 105, if it continues to travel at the set speed, will approach to within a specified minimum following distance from the detected vehicle. If so, the adaptive cruise control feature can temporarily reduce the speed of vehicle 105 below the set speed to prevent it from approaching any closer than the desired minimum following distance.

The adaptive cruise control feature of vehicle 105 can use data provided by radar and camera sensor(s) 115 of vehicle 105 to detect the presence of other vehicles on roadway 301. Using radar data, the vehicle 105 (e.g., via radar-based object detection provided by computer 110 or an ECU 112) can detect objects (such as other vehicles) within a radar range 302 that extends a distance D_{RR} forward from the front of vehicle 105. Using images captured by camera sensors(s) 115, the vehicle 105, e.g., via image-based object detection functionality provided by computer 110 or an ECU 112 can visually detect/recognize objects (such as other vehicles) within a vehicle camera range 304. Vehicle camera range 304 extends a distance D_{VCR} forward from the front of vehicle 105. In some implementations, as shown in the depicted example, vehicle camera range 304 can be smaller than radar range 302, such that D_{VCR} is less than D_{RR}. In other implementations, vehicle camera range 304 can be larger than radar range 302 (i.e., D_{VCR}>D_{RR}), or the two can be of the same size (i.e., D_{VCR}=D_{RR}).

In the standard operation mode, the adaptive cruise control feature of vehicle 105 can conduct adaptive cruise control state adjustments based on joint radar/visual obstacle discovery. As employed herein in reference to vehicle 105, the term “joint radar/visual obstacle discovery” means discovery of an obstacle in the travel path of vehicle 105 via mutually consistent radar-based object detection and image-based object detection. As employed herein, the term “travel path” means the collective portion of a roadway that a vehicle is expected to occupy as it travels along that roadway. For example, the travel path of a vehicle traveling along a two-way residential road subject to right-hand traffic (RHT) practices typically consists of the collective portion of upcoming roadway corresponding to the right-hand side of the road. In the case of a vehicle traveling along a roadway featuring lanes, the travel path of the vehicle typically consists of the collective portion of upcoming roadway corresponding to the travel lane of the vehicle.

In some cases, joint radar/visual obstacle discovery may involve an initial radar-based detection of an object, corroborated by a subsequent image-based detection of that object. In other cases, image-based detection may occur first, and may be corroborated by a subsequent radar-based detection. In yet other cases, joint radar/visual obstacle discovery may involve substantially simultaneous radar-based and image-based detection of an object.

Employing joint radar/visual (rather than radar-only or visual-only) obstacle discovery for adaptive cruise control state adjustments (e.g., adjustments to vehicle speed) can beneficially impact adaptive cruise control performance. For instance, when radar returns from stationary objects in the vicinity of a roadway (e.g., guardrails, bridges, overpasses, etc.) falsely suggest the presence of vehicles/obstacles on the roadway itself, image-based object detection can reveal that those objects are not actually obstacles in the travel path of the vehicle. In such cases, requiring visual corroboration can avoid unnecessary/inappropriate state adjustments (e.g., unnecessary deceleration/braking) that might otherwise result if action were taken on the basis of radar-based object detection alone.

In traffic scene 300, an obstacle 306—which may represent another vehicle or may represent some other object—is located in the travel path of vehicle 105, and within both radar range 302 and vehicle camera range 304. Assuming that vehicle 105 has use of its normal radar-based object detection and image-based object detection capabilities, joint radar/visual obstacle discovery of object 306 will be possible. On the other hand, joint radar/visual obstacle discovery may be impeded if either (or both) of vehicle 105's radar-based object detection and image-based object detection capabilities are degraded.

In an outdoor environment, the source, intensity, and direction of lighting can be in a state of frequent or constant change, an light-compromised conditions can hamper image-based object detection (and thus impede joint radar/visual obstacle discovery). For example, at times of day when the sun is low in the sky, bright sunlight shining directly into cameras of vehicles traveling towards the sun can wash out details in their captured images. At night, when lighting is not provided by the sun, captured images usable for image-based object detection can be difficult to obtain on roadways lacking sufficient supplemental lighting. Weather phenomena, such as the presence of clouds and/or precipitation, dense foliage, and other factors/circumstances can cause low-light conditions that degrade image-based object detection capabilities. If such light-compromised conditions exist in traffic scene 300, the image-based object detection capabilities of vehicle 105 may be degraded, which may hamper vehicle 105's ability to detect obstacle 306 via joint radar/visual obstacle discovery.

The presently described adaptive cruise control system can transition to a modified operation mode to optimize adaptive cruise control performance under light-compromised conditions. In the modified operation mode, adaptive cruise control operating parameters can be intelligently adjusted in various potential ways, depending on the type of light-compromised conditions in effect. Such adjustments can include, for example, changes to following distances, target speeds, acceleration/deceleration rates, acceleration/deceleration delay intervals, and other parameters. In some implementations, during operation in the modified operation mode, the importance/weight of image-based object detection in joint radar/visual obstacle discovery may be discounted. In some implementations, during operation in the modified operation mode, adaptive cruise control operating parameter adjustments may be permitted based on radar-based object detection alone, without image-based corroboration.

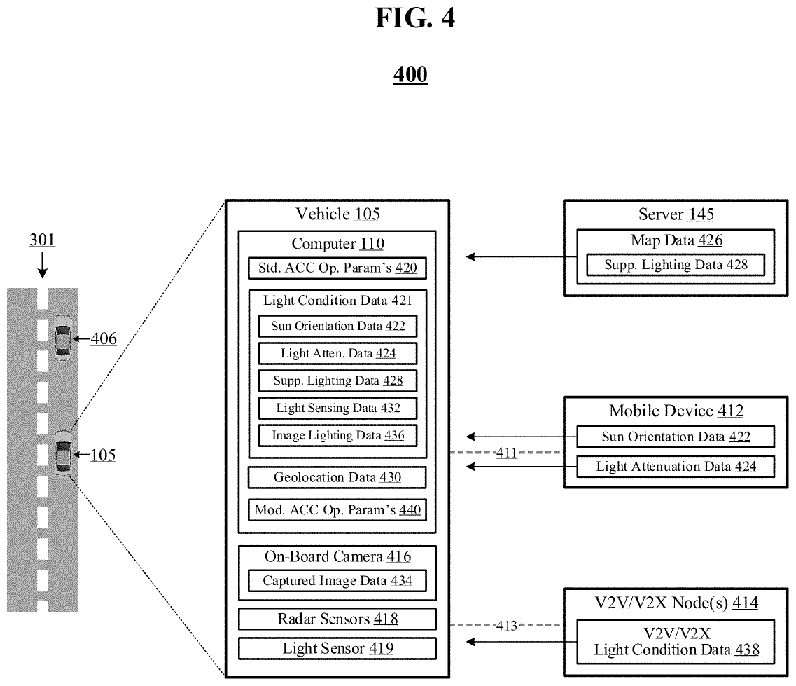

FIG. 4 is a block diagram of an example system 400 for intelligent adaptive cruise control for light-compromised conditions according to various implementations. System 400 includes vehicle 105 and server 145 of FIG. 1, a mobile device 412, and one or more V2V/V2X nodes 414. Vehicle 105 includes computer 110, an on-board camera 416, radar sensors 418, and a light sensor 419. Mobile device 412 can be a wireless communication device of a driver or passenger of vehicle 105. Vehicle 105 can communicate with mobile device 412 via a link 411. Link 411 can be a wireless (e.g., Bluetooth or WiFi) or a wired (e.g., USB or Ethernet) communication link between mobile device 412 and vehicle 105. Vehicle 105 can communicate with V2V/V2X nodes 414 via one or more V2V/V2X links 413. V2V/V2X links 413 can be wireless communication links, over which communications can be conducted in accordance with wireless communication protocols supporting vehicle-to-vehicle (V2V) communications and/or vehicle-to-infrastructure (V2X) communications, such as mentioned above. In some implementations, for instance, V2V/V2X links 413 can include cellular V2V (CV2V) and/or cellular V2X (CV2X) links, communications over which can be conducted in accordance with CV2V and/or CV2X protocols. System 400 can also include intermediate elements/nodes enabling communication between vehicle 105 and server 145, notwithstanding the fact that no such elements/nodes are depicted in FIG. 4. For example, in some implementations, system 400 can include network 135 of FIG. 1, which can convey communications between vehicle 105 and server 145, e.g., links 411, 413 can provide communications to the network 135.

FIG. 4 includes an illustration of a scenario in which vehicle 105 travels along roadway 301. Initially, an adaptive cruise control feature of vehicle 105 is set to operate in a standard operation mode. In some implementations, the adaptive cruise control feature may be in an active state, such that it is controlling propulsion power/acceleration to maintain a particular target speed. In other implementations, the adaptive cruise control feature may be in an inactive state, such that it is not controlling propulsion power/acceleration.

During operation in the standard operation mode, the adaptive cruise control feature operates in accordance with standard ACC operating parameters 420. A “parameter” in the context of this document is a value that provides a measurement of actual or possible vehicle operation. Standard ACC operating parameters 420 are parameters governing various aspects/behaviors of the adaptive cruise control feature in the standard operation mode.

In some implementations, standard ACC operating parameters 420 can include a target speed parameter. In such implementations, the value of the target speed parameter can specify/represent a speed to be maintained by vehicle 105 as it travels along roadway 301, when conditions allow (i.e., when there are no obstacles in the travel path of vehicle 105). In some implementations, the value of such a target speed parameter can be determined based on driver input. In some implementations, (e.g., implementations in which vehicle 105 is an autonomous or semi-autonomous vehicle), the value of such a target speed parameter can be determined algorithmically, based on factors such as speed limits, congestion levels, transit schedules, etc.

In some implementations, standard ACC operating parameters 420 can include a speed ceiling parameter. In such implementations, the value of the speed ceiling parameter can specify/represent a maximum allowable target speed of the adaptive cruise control feature during operation in the standard operation mode.

In some implementations, standard ACC operating parameters 420 can include a following distance parameter. In such implementations, the value of the following distance parameter can specify/represent a following distance that the adaptive cruise control feature should maintain between vehicle 105 and a vehicle in front of it (e.g., vehicle 406 in FIG. 4).

In some implementations, standard ACC operating parameters 420 can include a deceleration parameter. In such implementations, the value of the deceleration parameter can specify/represent the forcefulness with which vehicle 105 is to decelerate when reducing speed to account for the presence of an obstacle in the travel path of vehicle 105.

In some implementations, standard ACC operating parameters 420 can include a deceleration delay parameter. In such implementations, the value of the deceleration delay parameter can specify/represent an amount of time that the adaptive cruise control feature should wait before beginning deceleration when reducing speed to account for the presence of an obstacle in the travel path of vehicle 105.

In some implementations, standard ACC operating parameters 420 can include an acceleration parameter. In such implementations, the value of the acceleration parameter can specify/represent the forcefulness with which vehicle 105 is to accelerate back up to its target speed following a determination that the roadway in front of it is clear.

In some implementations, standard ACC operating parameters 420 can include an acceleration delay parameter. In such implementations, the value of the acceleration delay parameter can specify/represent an amount of time that the adaptive cruise control feature should wait before beginning acceleration back up to its target speed following a determination that the roadway in front of it is clear.

In some implementations, standard ACC operating parameters 420 can include a joint radar/visual detection requirement parameter, the value of which can indicate whether detection via both radar and camera imaging are required for obstacle discovery. In such implementations, the joint radar/visual detection requirement parameter can be set to a value indicating that obstacle discovery requires detection via both radar and camera imaging.

In some implementations, standard ACC operating parameters 420 can include a camera range parameter. In such implementations, the value of the camera range parameter can specify/represent an applicable camera range of on-board camera 416. In some implementations, the adaptive cruise control feature of vehicle 105 may attempt joint radar/visual obstacle discovery only with respect to potential obstacles within the applicable camera range of on-board camera 416, as indicated by the value of the camera range parameter. In some implementations, the camera range parameter can be set to a value indicating an applicable camera range corresponding to a camera range of on-board camera 416 under optimal lighting conditions.

As vehicle 105 travels along roadway 301, computer 110 can periodically and/or aperiodically (e.g., according to a non-periodic/event-based schedule, on demand, etc.) assess the lighting conditions in the field of view of on-board camera 416 to determine whether on-board camera 416 is subject to a light-compromised condition. As employed herein in reference to on-board camera 416, the term “light-compromised condition” means a condition in which aspects of the incident light in the field of view of on-board camera 416 (possibly including light incident upon on-board camera 416 itself, such as direct sunlight) affect image-based object detection capabilities of vehicle 105 to an extent sufficient to interfere with joint radar/visual obstacle discovery.

Various types of light-compromised conditions can interfere with image-based object detection using imaging of on-board camera 416. Direct sunlight can wash out captured images of on-board camera 416 when vehicle 105 travels towards the sun, if the sun is low enough to appear within the field of view of on-board camera 416. Sufficient light for image-based object detection may be lacking during nighttime operation on roadways that do not feature sufficient supplemental lighting. Cloud cover, precipitation, foliage, and/or other factors can hamper image-based object detection as well.

Computer 110 can assess the lighting conditions in the field of view of on-board camera 416, and determine whether on-board camera 416 is subject to a light-compromised condition, based on light condition data 421. Computer 110 can obtain portions of lighting condition data 421 from various sources, which can include any or all of server 145, mobile device 412, and V2V/V2X node(s) 414. Lighting condition data 421 can include various types of data, such as any or all of sun orientation data 422, light attenuation data 424, supplemental lighting data 428, light sensing data 432, and image lighting data 436.

Sun orientation data 422 is data that specifies an orientation of the sun with respect to a location on the earth (e.g., the location of vehicle 105). In some implementations, sun orientation data 422 can indicate a solar azimuth angle and solar zenith or solar elevation angle describing the position of the sun as observed from the location of vehicle 105. Based on sun orientation data 422, computer 110 can determine whether—and if so, where—the sun is located within the field of view of on-board camera 416. In some implementations, computer 110 can determine whether the sun is located within the field of view of on-board camera 416 based on the direction of travel of vehicle 105 and the position of the sun as observed from the location of vehicle 105. In some implementations, computer 110 can determine the direction of travel of vehicle 105 based on compass data (e.g., provided by a compass of vehicle 105).

In some implementations, mobile device 412 (e.g., an application executing on mobile device 412) can obtain sun orientation data 422 from a source external to system 400 (e.g., by communicating with a remote server via the Internet) and can then provide sun orientation data 422 to computer 110 via link 411. In some implementations, mobile device 412 can submit geolocation data 430 indicating the location of vehicle 105 to such an external source, and can receive sun orientation data 422 from the external source in response. In some such implementations, vehicle 105 can include a global navigation satellite system (GNSS) receiver (e.g., a Global Positioning System (GPS) receiver) that generates geolocation data 430, and vehicle 105 can provide geolocation data 430 to mobile device 412. Alternatively or additionally, mobile device 412 can generate geolocation data 430 itself (e.g., using its own GPS/GNSS receiver). In some implementations, rather than (or in addition to) obtaining sun orientation data 422 from mobile device 412, computer 110 can obtain sun orientation data 422 from server 145 or from a V2V/V2X node 414 (as V2V/V2X light condition data 438, further discussed below), or can obtain sun orientation data 422 directly from an external source (e.g., by communicating with a remote server via the Internet).

Light attenuation data 424 is data indicating whether/to what extent weather conditions at the location of vehicle 105 reduce the amount/intensity of sunlight and/or supplemental light shining upon the roadway 301 in front of vehicle 105. In some implementations, light attenuation data 424 can include data indicating an extent of cloud cover (if any) at the location of vehicle 105. In such implementations, computer 110 can take the extent of cloud cover—and the extent to which it reduces the amount/intensity of incident sunlight—into account in conjunction with assessing the lighting conditions in the field of view of on-board camera 416 during daylight hours. In some implementations, light attenuation data 424 can include data describing a type and/or intensity of precipitation currently falling at the location of vehicle 105. In such implementations, computer 110 can take the type and/or intensity of precipitation (if any) currently falling at the location of vehicle 105—and the extent to which it reduces the amount/intensity of incident sunlight and/or supplemental light—into account in conjunction with assessing the lighting conditions in the field of view of on-board camera 416.

In some implementations, mobile device 412 (e.g., an application executing on mobile device 412) can obtain light attenuation data 424 from a source external to system 400 (e.g., by communicating with a remote server via the Internet) and can then provide light attenuation data 424 to computer 110 via link 411. In some implementations, mobile device 412 can submit geolocation data 430 indicating the location of vehicle 105 to such an external source, and can receive light attenuation data 424 from the external source in response. In some implementations, rather than (or in addition to) obtaining light attenuation data 424 from mobile device 412, computer 110 can obtain light attenuation data 424 from server 145 or from a V2V/V2X node 414 (as V2V/V2X light condition data 438, further discussed below), or can obtain light attenuation data 424 directly from an external source (e.g., by communicating with a remote server via the Internet).

Supplemental lighting data 428 is data indicating whether supplemental lighting sources (e.g., street lights/lamps, light poles, lampposts, other forms of highway/roadway lighting, light from nearby signs and/or buildings, etc.) are present at/near the location of vehicle 105 that may generate light affecting the lighting conditions in the field of view of on-board camera 416. In some implementations, supplemental lighting data 428 can reflect prior observations of the existence/extent of supplemental lighting at/near the location of vehicle 105 as reported (e.g., to server 145) by vehicles that have previously passed through that location. In some implementations, supplemental lighting data 428 may be incorporated into map data 426, which may be provided by server 145 (as depicted in FIG. 4) or mobile device 412, and/or may be provisioned to vehicle 105 in another way (e.g., OTA communications, on-site provisioning at a service center, etc.). In some implementations, computer 110 may identify and obtain supplemental lighting data 428 from within map data 426 based on the location of vehicle 105, which computer 110 may determine based on geolocation data 430. In some implementations, computer 110 can obtain some or all of supplemental lighting data 428 from a V2V/V2X node 414 (as V2V/V2X light condition data 438, further discussed below), or can obtain light attenuation data 424 directly from an external source (e.g., by communicating with a remote server via the Internet).

Light sensing data 432 is data indicating one or more direct measurements of the amount/intensity of light at vehicle 105. In some implementations, light sensing data 432 can be provided by light sensor 419. In some implementations, light sensor 419 can be a sensor that takes measurements used in controlling other features of vehicle 105. In some implementations, for example, light sensor 419 can be a windshield-mounted sensor that takes measurements used in controlling automatic headlights and/or windshield wipers of vehicle 105.

Image lighting data 436 is data indicating characteristics of light in the field of view of on-board camera 416, as observed using on-board camera 416 itself. Computer 110 can obtain captured image data 434 from on-board camera 416, and can process captured image data 434 to obtain image lighting data 436. Captured image data 434 can comprise image data corresponding to one or more images captured by on-board camera 416. Image lighting data 436 can indicate the apparent amount/intensity of light in the field of view of on-board camera 416. Image lighting data 436 can additionally or alternatively indicate other characteristic(s) of the light in field of view of on-board camera 416. For example, in some implementations, image lighting data 436 can indicate any or all of a degree of patchiness/non-uniformity of light (due to patches of shade caused by foliage, for example), the presence or absence of cloud cover and/or precipitation, the presence or absence of the sun within the field of view (and if present, its position within the field of view), and the presence or absence of supplemental lighting and sources thereof.

In some implementations, computer 110 can use image lighting data 436 to verify aspects of any or all of sun orientation data 422, light attenuation data 424, and supplemental lighting data 428. For example, in some implementations, computer 110 can use image lighting data 436 to confirm that the sun is in a position within the field of view of on-board camera 416 that it should be according to sun orientation data 422. In another example, in some implementations, computer 110 can use image lighting data 436 to verify the presence of precipitation that should be present according to light attenuation data 424. In a third example, in some implementations, computer 110 can use image lighting data 436 to confirm the presence and/or position of supplemental lighting sources that should be present according to supplemental lighting data 428.

In some implementations, one or more V2V/V2X nodes 414 in the vicinity of vehicle 105 can share relevant data with vehicle 105 in the form of V2V/V2X light condition data 438. V2V/V2X node(s) 414 can be other vehicles in the vicinity of vehicle 105, infrastructure nodes in the vicinity of vehicle 105, or a combination of both. Vehicle 105 can receive V2V/V2X light condition data 438 via one or more V2V/V2X links 413. V2V/V2X light condition data 438 can indicate aspects of lighting conditions in the vicinity of vehicle 105, as observed/determined by the one or more V2V/V2X nodes 414. Portions of V2V/V2X light condition data 438 can be included among any or all of sun orientation data 422, light attenuation data 424, supplemental lighting data 428, light sensing data 432, and image lighting data 436.

Computer 110 can apply a lighting assessment algorithm in conjunction with determining, based on light condition data 421, whether on-board camera 416 is subject to a light-compromised condition. Depending on the design/characteristics of the particular lighting assessment algorithm used, computer 110 may base a determination of whether on-board camera 416 is subject to a light-compromised condition on any or all (or none) of sun orientation data 422, light attenuation data 424, supplemental lighting data 428, light sensing data 432, and image lighting data 436.

Responsive to a determination that on-board camera 416 is subject to a light-compromised condition, computer 110 can cause the adaptive cruise control feature of vehicle 105 to operate in a modified operation mode. The adaptive cruise control feature of vehicle 105 can, generally speaking, behave more conservatively during operation in the modified operation mode than it does in the standard operation mode, to account for the existence/effects of the light-compromised condition. For instance, in the modified operation mode, the adaptive cruise control feature can cause vehicle 105 to keep further back from vehicles in front of it, accelerate less forcefully, and/or wait longer before accelerating in response to detecting newly-clear road ahead.

In some implementations, during operation in the modified operation mode, the adaptive cruise control feature can rely more heavily on data from radar sensor 418 for obstacle discovery and control of vehicle speed/performance, and less heavily (or not at all) on captured image data 434 from on-board camera 416. In some implementations, during operation in the modified operation mode, the adaptive cruise control feature may permit obstacle discovery based on data from radar sensor 418 without visual confirmation/corroboration based on captured image data 434.

In some implementations, during operation in the modified operation mode, the adaptive cruise control feature of vehicle 105 can lift the throttle and/or begin light braking in response to radar-based detection of an apparent obstacle in the travel path of vehicle 105, without waiting for image-based detection/confirmation of the apparent obstacle. In some implementations, the adaptive cruise control feature can maintain an increased following distance (relative to a following distance that would be maintained in the standard operation mode) between vehicle 105 and the apparent obstacle. In some implementations, during operation in the modified operation mode, the adaptive cruise control feature can implement a reduced target speed, which can be determined as a function of an applicable speed limit for the roadway 301 (e.g., as equal to the applicable speed limit minus an offset) and/or as a function of a driver-specified or algorithmically-determined set speed (e.g., as equal to the set speed minus an offset). In some implementations, the adaptive cruise control feature can cause an alert to be presented on a human-machine interface (HMI) of vehicle 105 to notify a driver of vehicle 105 that the adaptive cruise control feature is operating in the modified operation mode.

During operation in the modified operation mode, the adaptive cruise control feature can operate in accordance with modified ACC operating parameters 440. Modified ACC operating parameters 440 are parameters governing various aspects/behaviors of the adaptive cruise control feature in the modified operation mode, and can be selected to induce more conservative behavior on the part of the adaptive cruise control feature in a desired manner.

In some implementations, modified ACC operating parameters 440 can include a modified target speed parameter. In such implementations, the modified target speed parameter can be set to a reduced value (relative to a target speed parameter comprised among standard ACC operating parameters 420), to marginally reduce the speed that vehicle 105 maintains while the roadway in front of it is clear when on-board camera 416 is subject to a light-compromised condition.

In some implementations, modified ACC operating parameters 440 can include a modified speed ceiling parameter. In such implementations, the modified speed ceiling parameter can be set to a reduced value (relative to a speed ceiling parameter comprised among standard operating parameters 420), such that during operation in the modified operation mode, the adaptive cruise control feature is limited to a maximum allowable target speed that is less than that to which it is limited during operation in the standard operation mode.

In some implementations, modified ACC operating parameters 440 can include a modified following distance parameter. In such implementations, the value of the modified following distance parameter can be selected so that the adaptive cruise control feature maintains a larger following distance between vehicle 105 and the vehicle in front of it (e.g., vehicle 406 in FIG. 4) while in the modified operation mode than it would in the standard operation mode.

In some implementations, modified ACC operating parameters 440 can include a modified deceleration parameter. In such implementations, the value of the modified deceleration parameter can be selected so that following discovery of an obstacle in its travel path, vehicle 105 decelerates more forcefully than it would in the standard operation mode.

In some implementations, modified ACC operating parameters 440 can include a modified deceleration delay parameter. In such implementations, the value of the modified deceleration delay parameter can be selected so that following discovery of an obstacle in its travel path, vehicle 105 waits a lesser amount of time before beginning deceleration than it would in the standard operation mode.

In some implementations, modified ACC operating parameters 440 can include a modified acceleration parameter. In such implementations, the value of the modified acceleration parameter can be selected so that following a determination that the roadway in front of it is clear while in the modified operation mode, vehicle 105 accelerates back up to its target speed less forcefully than it would in the standard operation mode.

In some implementations, modified ACC operating parameters 440 can include a modified acceleration delay parameter. In such implementations, the value of the modified acceleration delay parameter can be selected so that following a determination that the roadway in front of it is clear while in the modified operation mode, vehicle 105 waits longer to begin accelerating back up to its target speed than it would in the standard operation mode.

In some implementations, modified ACC operating parameters 440 can include a modified joint radar/visual detection requirement parameter. In some such implementations, the modified joint radar/visual detection requirement parameter can be set to a value indicating that obstacle discovery does not require detection via camera imaging.

In some implementations, modified ACC operating parameters 440 can include a modified camera range parameter. In such implementations, the modified camera range parameter can be set to a reduced value (relative to a camera range parameter comprised among standard ACC operating parameters 420) indicating a reduced effective camera range corresponding to that of on-board camera 416 under the detected light-compromised conditions.

In some implementations, various combinations of values for modified ACC operating parameters 440 can be empirically tested to evaluate their suitability with respect to eliciting desired results/behaviors on the part of the adaptive cruise control feature in the modified operation mode. In some implementations, an iterative testing process can be used to calibrate the respective values of a set of modified ACC operating parameters 440 as appropriate to optimize adaptive cruise control behavior/performance in the modified operation mode.

In some implementations, computer 110 can recognize and distinguish between multiple light-compromised condition levels, which can correspond to different degrees/types of light impairment/deficiency. In such embodiments, in conjunction with applying a lighting assessment algorithm, computer 110 can determine a particular light-compromised condition level to which on-board camera 416 is subject. For example, in some implementations, computer 110 can recognize and distinguish between a first light-compromised condition level corresponding to circumstances in which direct sunlight is shining into on-board camera 416 (i.e., the sun is within the field of view of on-board camera 416), a second light-compromised condition level corresponding to especially low lighting conditions (e.g., nighttime travel on a roadway lacking supplemental lighting), and a third light-compromised condition level corresponding to moderately low lighting conditions (e.g., travel at or near dawn/dusk, nighttime travel on road with significant supplemental lighting).

In some implementations, multiple modified operation modes can be defined and implemented, and responsive to a determination that on-board camera 416 is subject to a light-compromised condition, computer 110 can cause the adaptive cruise control feature to operate in a particular one of those multiple modified operation modes. In some implementations, computer 110 can select the particular modified operation mode based on any or all of sun orientation data 422, light attenuation data 424, supplemental lighting data 428, light sensing data 432, and image lighting data 436. In some implementations, a respective modified operation mode can be designated for each of multiple light-compromised condition levels, and computer 110 can cause the adaptive cruise control feature to operate in a designated modified operation mode for the particular light-compromised condition level to which on-board camera 416 is subject. For example, first, second, and third modified operation modes can be designated for the aforementioned first, second, and third light-compromised condition levels, respectively, and computer 110 can cause the adaptive cruise control feature to operate in the second modified operation mode responsive to a determination that on-board camera 416 is subject to the second light-compromised condition level.

In some implementations, different sets of values for modified ACC operating parameters 440 can be recognized/selected for different respective light-compromised condition levels. Each such set can serve as the modified ACC operating parameters 440 for a modified operation mode associated with a respective one of the light-compromised condition levels. For instance, first, second, and third sets of values for modified ACC operating parameters 440 can be recognized/selected for the respective first, second, and third light-compromised condition levels discussed above, and can serve as the modified ACC operating parameters 440 for the first, second, and third modified operation modes, respectively. In some implementations, empirical testing can be used to evaluate, for each of multiple light-compromised condition levels, the suitability of various combinations of values for modified ACC operating parameters 440. In some implementations, for each of multiple light-compromised condition levels, an iterative testing process can be used to calibrate the respective values of a set of modified ACC operating parameters 440 to best realize desirable adaptive cruise control behavior/performance for that light-compromised condition level.

In some implementations, operation of the adaptive cruise control feature of vehicle 105 in a modified operation mode can be guided by one or more rules/policies governing aspects of the behavior of the adaptive cruise control feature in that particular mode. In some implementations, such rules/policies can include rules/policies requiring particular actions/operations on the part of the adaptive cruise control feature. For example, in some implementations, a rule applying to a modified operation mode may require that a driver alert be presented (e.g., via a human-machine interface (HMI)) to provide driver notification when the adaptive cruise control feature transitions from the standard operation mode to that modified operation mode. In some implementations, constraints imposed by any particular rule/policy can depend on values of one or more modified ACC operating parameters 440. For instance, continuing the previous example, an additional rule applying to the modified operation mode can specify that the driver alert must be presented for a certain amount of time before the driver can increase the set speed of the adaptive cruise control, and that certain amount of time may be defined by the value of a modified ACC operating parameter 440.

Table 1 illustrates aspects of adaptive cruise control operations in a standard operation mode and each of three modified operation modes (“Mod-1”, “Mod-2”, and “Mod-3”) according to an example implementation. Modified operation mode Mod-1 is designed for use during light-compromised conditions in which on-board camera 416 is sun-blinded (i.e., when sunlight is shining directly into on-board camera 416). Modified operation mode Mod-2 is designed for use during conditions of especially low light, such as nighttime operation on roadways that lack supplemental lighting. Modified operation mode Mod-3 is designed for use during conditions of moderately low light, such as operation at or near dawn or dusk.

TABLE 1

| Operation | Nature of Light- | | Following | Target Speed |
|---|---|---|---|---|
| Mode | Compromised Condition | Camera Usage? | Distance | Ceiling |
| Standard | — | Yes | D_{F} | S_{T-max} |
| | | (Range = D_{VCR}) | | |
| Mod-1 | sun-blinded camera | No | 1.5*D_{F} | 0.8*S_{T-max} |
| Mod-2 | especially low light | Yes | 1.25*D_{F} | 0.9*S_{T-max} |
| | (e.g., nighttime operation | (Range = 0.5*D_{VCR}) | | |
| | w/o supplemental lighting) | | | |
| Mod-3 | moderately low light | Yes | 1.1*D_{F} | 0.95*S_{T-max} |
| | (e.g., operation at | (Range = 0.9*D_{VCR}) | | |
| | dawn/dusk) | | | |

According to the example implementation illustrated in Table 1, during operation in the standard operation mode, the adaptive cruise control feature uses on-board camera 416 for obstacle discovery (e.g., joint radar/visual obstacle discovery), and does so with respect to potential obstacles within the full camera range D_{VCR} of on-board camera 416. A following distance D_{F} is maintained between vehicle 105 and any leading vehicle (e.g., vehicle 406 in FIG. 4), and the maximum allowable target speed of the adaptive cruise control feature is a speed ceiling S_{T-max}.

In modified operation mode Mod-1, on-board camera 416 is not used for obstacle discovery. The following distance maintained between vehicle 105 and any leading vehicle is increased by 50% relative to that maintained in the standard operation mode, and the maximum allowable target speed of the adaptive cruise control feature is reduced by 20% relative to the applicable maximum of the standard operation mode.

In modified operation mode Mod-2, on-board camera 416 is used for obstacle discovery, but only with respect to potential obstacles within a reduced camera range of 0.5*D_{VCR}. The following distance maintained between vehicle 105 and any leading vehicle is increased by 25% relative to that maintained in the standard operation mode, and the maximum allowable target speed of the adaptive cruise control feature is reduced by 10% relative to the applicable maximum of the standard operation mode.

In modified operation mode Mod-3, on-board camera 416 is used for obstacle discovery, but only with respect to potential obstacles within a reduced camera range of 0.9*D_{VCR}. The following distance maintained between vehicle 105 and any leading vehicle is increased by 10% relative to that maintained in the standard operation mode, and the maximum allowable target speed of the adaptive cruise control feature is reduced by 5% relative to the applicable maximum of the standard operation mode.

While the adaptive cruise control feature of vehicle 105 operates in a modified operation mode following a determination that on-board camera 416 is subject to a light-compromised condition, computer 110 can continue to periodically and/or aperiodically assess the lighting conditions in the field of view of on-board camera 416 to determine whether the light-compromised condition persists. In response to a determination on-board camera 416 is no longer subject to the light-compromised condition, computer 110 can cause the adaptive cruise control feature to transition back to the standard operation mode. In implementations in which multiple modified operation modes are defined, computer 110 can cause the adaptive cruise control feature to transition from one modified operation mode to another modified operation mode responsive to a determination that on-board camera 416 is subject to a different light-compromised condition than it was initially. In some implementations, a hysteresis function may be implemented to prevent undesirable toggling between/among the standard operation mode and the modified operation mode(s).

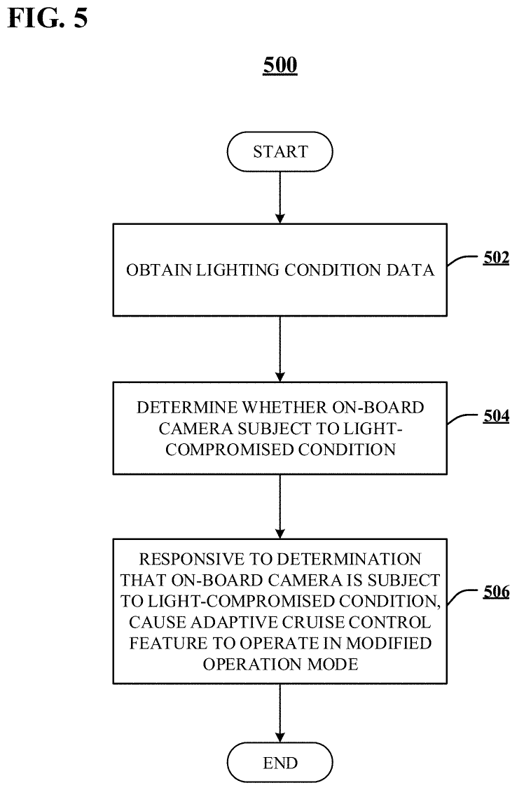

FIG. 5 is a block diagram of a process flow 500, which may be representative of operations executed in various implementations. As shown in process flow 500, lighting condition data for an on-board camera of a vehicle traveling a roadway may be obtained at 502 while an adaptive cruise control feature of the vehicle is set to operate in a standard operation mode. For example, computer 110 may obtain lighting condition data 421 for on-board camera 416 while vehicle 105 travels roadway 301 with its adaptive cruise control feature set to operate in a standard operation mode. At 504, it may be determined, based on the lighting condition data, whether the on-board camera is subject to a light-compromised condition. For example, computer 110 may determine whether on-board camera 416 is subject to a light-compromised condition based on lighting condition data 421. At 506, the adaptive cruise control feature may be caused to operate in a modified operation mode responsive to a determination that the on-board camera is subject to a light-compromised condition. For example, computer 110 can cause the adaptive cruise control feature of vehicle 105 to operate in a modified operation mode responsive to a determination that on-board camera 416 is subject to a light compromised condition.

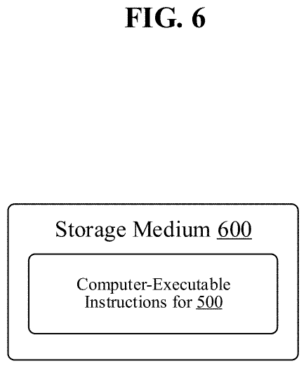

FIG. 6 illustrates an example storage medium 600. Storage medium 600 may be any non-transitory computer-readable storage medium or machine-readable storage medium, such as an optical, magnetic or semiconductor storage medium. In various implementations, storage medium 600 may be an article of manufacture. In some implementations, storage medium 600 may store computer-executable instructions, such as computer-executable instructions to implement process flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some implementations, the circuitry may be implemented in, or functions associated with the circuitry may be implemented by, one or more software or firmware modules. In some implementations, circuitry may include logic, at least partially operable in hardware.

As used herein, the adverb “substantially” means that a shape, structure, measurement, quantity, time, etc. may deviate from an exact described geometry, distance, measurement, quantity, time, etc., because of imperfections in materials, machining, manufacturing, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described. The present invention is intended to be limited only by the following claims.

What is claimed is:

1. A system, comprising:
a computer having a processor and a memory, the memory storing instructions executable by the processor to:
obtain, while an adaptive cruise control feature of a vehicle traveling a roadway is set to operate in a standard operation mode, lighting condition data for an on-board camera of the vehicle;
determine, based on the lighting condition data, whether the on-board camera is subject to a light-compromised condition; and
responsive to a determination that the on-board camera is subject to the light-compromised condition, cause the adaptive cruise control feature to operate in a modified operation mode, wherein during operation in the modified operation mode, the adaptive cruise control feature operates in accordance with one or more modified operating parameters.

2. The system of claim 1, wherein the lighting condition data includes sun orientation data indicating an orientation of the sun relative to an orientation of the vehicle.

3. The system of claim 1, wherein the lighting condition data includes light attenuation data indicating at least one of:
an extent of cloud coverage at the location of the vehicle; and
an extent of precipitation at the location of the vehicle.

4. The system of claim 1, wherein the lighting condition data includes supplemental lighting data describing an extent of supplemental lighting at the location of the vehicle.

5. The system of claim 4, wherein the memory stores instructions executable by the processor to:
determine the location of the vehicle based on geolocation data; and
obtain the supplemental lighting data from map data based on the location of the vehicle.

6. The system of claim 1, wherein the lighting condition data includes light sensing data obtained from a light sensor of the vehicle.

7. The system of claim 1, wherein the memory stores instructions executable by the processor to obtain at least a portion of the lighting condition data by processing captured image data obtained from the on-board camera.

8. The system of claim 1, wherein the memory stores instructions executable by the processor to determine whether the on-board camera is subject to the light-compromised condition based on:
the lighting condition data; and
a current time of day.

9. The system of claim 1, wherein the one or more modified operating parameters include a modified following distance parameter.

10. The system of claim 1, wherein the one or more modified operating parameters include a modified target speed parameter.

11. A method, comprising:
obtaining, while an adaptive cruise control feature of a vehicle traveling a roadway is set to operate in a standard operation mode, lighting condition data for an on-board camera of the vehicle;
determining, based on the lighting condition data, whether the on-board camera is subject to a light-compromised condition; and
responsive to a determination that the on-board camera is subject to the light-compromised condition, causing the adaptive cruise control feature to operate in a modified operation mode, wherein during operation in the modified operation mode, the adaptive cruise control feature operates in accordance with one or more modified operating parameters.

12. The method of claim 11, wherein the lighting condition data includes sun orientation data indicating an orientation of the sun relative to an orientation of the vehicle.

13. The method of claim 11, wherein the lighting condition data includes light attenuation data indicating at least one of:
an extent of cloud coverage at the location of the vehicle; and
an extent of precipitation at the location of the vehicle.

14. The method of claim 11, wherein the lighting condition data includes supplemental lighting data describing an extent of supplemental lighting at the location of the vehicle.

15. The method of claim 14, comprising:
determining the location of the vehicle based on geolocation data; and
obtaining the supplemental lighting data from map data based on the location of the vehicle.

16. The method of claim 11, wherein the lighting condition data includes light sensing data obtained from a light sensor of the vehicle.

17. The method of claim 11, comprising obtaining at least a portion of the lighting condition data by processing captured image data obtained from the on-board camera.

18. The method of claim 11, comprising determining whether the on-board camera is subject to the light-compromised condition based on:
the lighting condition data; and
a current time of day.

19. The method of claim 11, wherein the one or more modified operating parameters include a modified following distance parameter.

20. The method of claim 11, wherein the one or more modified operating parameters include a modified target speed parameter.
